(19) United States
(12) Patent Application Publication
(10) Pub. No.: US 2009/0160606 A1
(43) Pub. Date: Jun. 25, 2009

(54) Lock System with User Self-Enrollment Method

(76) Inventors: Kevin D. Miller, Farmington, CT (US); George Frolov, Farmington, CT (US)

Correspondence Address: MICHAEL BEST & FRIEDRICH LLP, 100 EAST WISCONSIN AVE, SUITE 3300, MILWAUKEE, WI, 53202-4108, US

(21) Appl. No.: 11/885,100

(22) PCT Filed: Feb. 24, 2006
(86) PCT No.: PCT/US06/06510

§ 371 Date: Aug. 24, 2007

Related U.S. Application Data
(60) Provisional application No. 60/656,269, filed on Feb. 25, 2005.

(51) Int. Cl. G05B 19/00

(52) U.S. Cl. 340/5.54

(57) ABSTRACT

A lock system (10) includes a lock adjustable between locked and unlocked configurations and at least one and preferably two input devices (30, 22) each configured to generate or/and receive user input, each input having a value. A controller (16) is operatively with the lock, coupled with the input device(s) (22, 30) to receive user input, and has memory with at least first and second data files, the first file having at least one stored value. The controller (16) is configured to receive first and second user inputs, to compare the first input value with the first file(s) value, and to store a particular second input value within the second data file when the particular first input value correspond with at least one value in the first file, thus enrolling the user. Thereafter, the lock is preferably unlocked using only the second user input, which is carried by a key unit or a user physical feature.

The present invention relates to locks, and more particularly to controllers used with electronic lock systems, the programming of such controllers and the methods of operating such locks.

Certain locks include a latch or bolt movably disposed within a door and engageable with a strike in a frame to secure the door thereto. Some of these locks are electromechanical and include either a clutch mechanism to removably connect at least one handle with the latch/bolt or a movable blocking member used to releasably prevent handle rotation (and thereby latch retraction) or directly restrain the latch or bolt. These electromechanical locks generally include an actuator for displacing the clutch or moveable “block” and a controller configured to operate the actuator when receiving an authorized “unlock” signal from an appropriate input device. Other locks are “electromagnetic” and include an electromagnet that magnetically engages with a metallic plate so as to secure a door within a frame. Typically, an actuator (e.g., a relay or other switch) controls power to the magnet and a controller is configured to operate the actuator when receiving an authorized “unlock” signal.

With both the electromechanical and electromagnetic locks, the controller must be able to determine when an input is authorized. Typically, these controllers store a “list” or file of codes/values that indicate authorized users, and will operate the associated actuator when a particular input matches at least one stored code/value.

### SUMMARY OF THE INVENTION

In one aspect, the present invention is a lock system comprising a lock adjustable between a locked configuration and an unlocked configuration and at least one input device configured to generate user input, each user input having a value. A controller is operatively connected with the lock, is coupled with the input device so as to receive user input, and has a memory with at least first and second data files, the first file having at least one stored value. The controller is configured to receive first and second user inputs and to compare the first input value with the at least one first file value. Further, the controller is configured to store a particular second input value within the second data file when a particular value of the first input corresponds with at least one value in the first file.

In another aspect, the present invention is a method of managing a plurality of lock assemblies. The method comprises the steps of: providing a plurality of the lock assemblies, each lock assembly including a lock adjustable between a locked configuration and an unlocked configuration, and an input device configured to generate user input, and a controller operatively connected with the lock, coupled with the input device so as to receive user input, having a memory with at least first and second data files; storing at least one first value into each lock first data file; inputting first and second user values into at least one the lock controllers; and storing the second user value in the controller second data file when the first user value corresponds with at least one value stored in the controller first data file such that the controller adjusts the lock to the unlocked configuration whenever the second user value is subsequently inputted to the controller.

In another aspect, the present invention is again a lock system comprising a lock adjustable between a locked configuration and an unlocked configuration and at least one input device configured to generate user input, each user input having a value. A controller is operatively connected with the lock and coupled with the input device so as to receive user input. The controller includes a database having at least one record with first and second fields, the first field having a value. Further, the controller is configured to receive first and second user inputs and to compare the first input value with the first field value and to store the second input value within the second field when the particular first input value corresponds with the first field value.

In an even further aspect, the present invention is also a lock system for a door disposed within a frame, the lock system comprising a lock adjustable between a locked configuration and an unlocked configuration and at least one input device configured to receive user input, each user input having a value. A controller is operatively connected with the lock and coupled with the input device so as to receive user input and has a memory with at least first and second data files, the first data file having at least one value.

The controller is configured to receive two user inputs and to compare the value of a predetermined one of the two inputs with the at least one first file value and to store the value of the other one of the two inputs within the second file when the particular value of the one input corresponds with one first file value.

In yet another aspect, the present invention is again a method of managing a plurality of lock assemblies, the method comprising the following steps: providing a plurality of the lock assemblies, each lock assembly including a lock adjustable between a locked configuration and an unlocked configuration, and an input device configured to generate user input, and a controller operatively connected with the lock, coupled with the input device so as to receive user input, and having a memory with at least first and second data files; providing a programming device having a memory with a set of values; copying the set of values from the programming device memory into the lock controller first data file of each one of the locks; inputting first and second user values into at least one the lock controllers; and storing the second user value in the controller second data unit when the first user value corresponds with at least one of the set of values stored in the controller first data file such that the controller adjusts the lock to the unlocked configuration whenever the second user value is subsequently inputted to the controller.

### BRIEF DESCRIPTION OF THE SEVERAL VIEWS OF THE DRAWINGS

The foregoing summary, as well as the detailed description of the preferred embodiments of the present invention, will be better understood when read in conjunction with the appended drawings. For the purpose of illustrating the invention, there is shown in the drawings, which are diagrammatic, embodiments that are presently preferred. It should be understood, however, that the present invention is not limited to the precise arrangements and instrumentalities shown. In the drawings:

FIG. 1 is a more diagrammatic, overall view of an exemplary lock system in accordance with the present invention;

FIG. 2 is logic flow diagram depicting the basic operations of a controller of each lock assembly;

FIGS. 3A and 3B, collectively FIG. 3, are each a schematic view of a separate lock assembly of the lock system, each shown mounted to a separate door;

FIGS. 4A and 4B, collectively FIG. 4, are two schematic views of a controller and two input devices, the first showing entry of a first set of first and second inputs and the second showing entry of a second set of first and second inputs;

FIG. 5 is a partly broken away, elevational view of a representative lock assembly, shown mounted to a door;

FIG. 6 is a more diagrammatic view of a programming device and a data transfer device of the lock system;

FIG. 7 is a more diagrammatic view of the data transfer device coupled with the controller of one lock assembly;

FIG. 8 is a more diagrammatic view of one lock controller and two alternative lock structures coupled with the controller;

FIG. 9 is a schematic view of a controller with a database, showing a first, user record table thereof;

FIG. 10 is another view of the controller of FIG. 9, shown with randomly-selected data values for purposes of illustration; and

FIG. 11 is a view of a second, lock history table of the database.

### DETAILED DESCRIPTION OF THE INVENTION

Certain terminology is used in the following description for convenience only and is not limiting. As used herein, the words “connected” and “coupled” are each intended to include direct connections between two members without any other members interposed therebetween, indirect connections between members in which one or more other members are interposed therebetween, and operative or functional connections in which a physical connection may or may not exist. Also, the word “program” as used herein includes any and all types of computer programs, software, series of instructions, etc., that a computer can interpret and execute. Further, as used herein, the term “file” is intended to encompass any and all types of data entities, information units, etc., and collections of such data entities/information units, storable in electronic, electromagnetic, or any other appropriate storage media, and is in no manner limited to any specific data/information structure, device, etc. The terminology includes the words specifically mentioned above, derivatives thereof, and words of similar import.

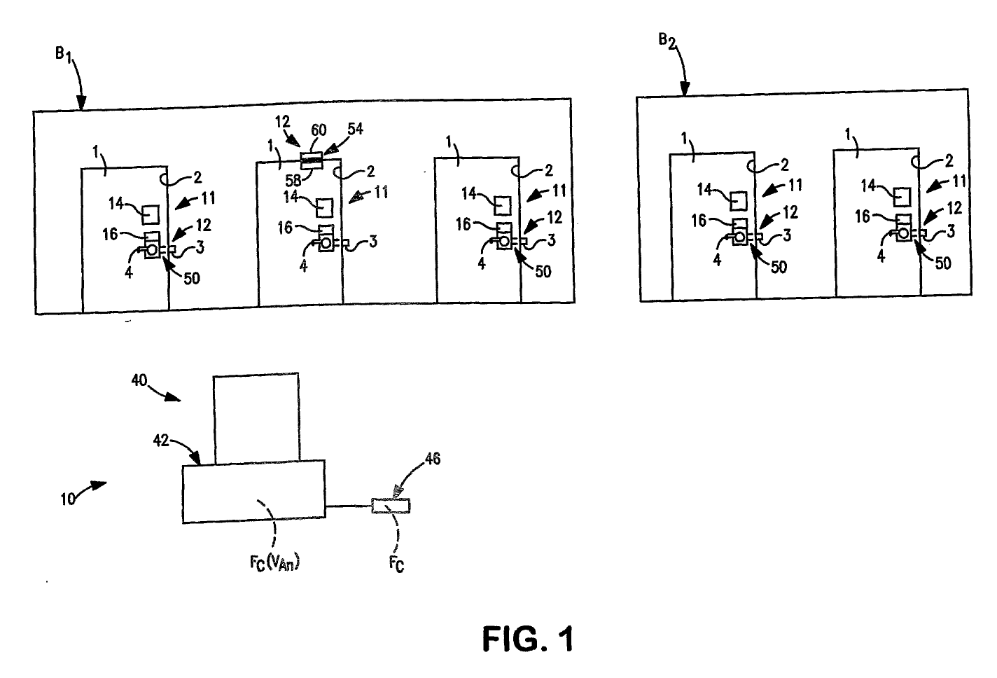

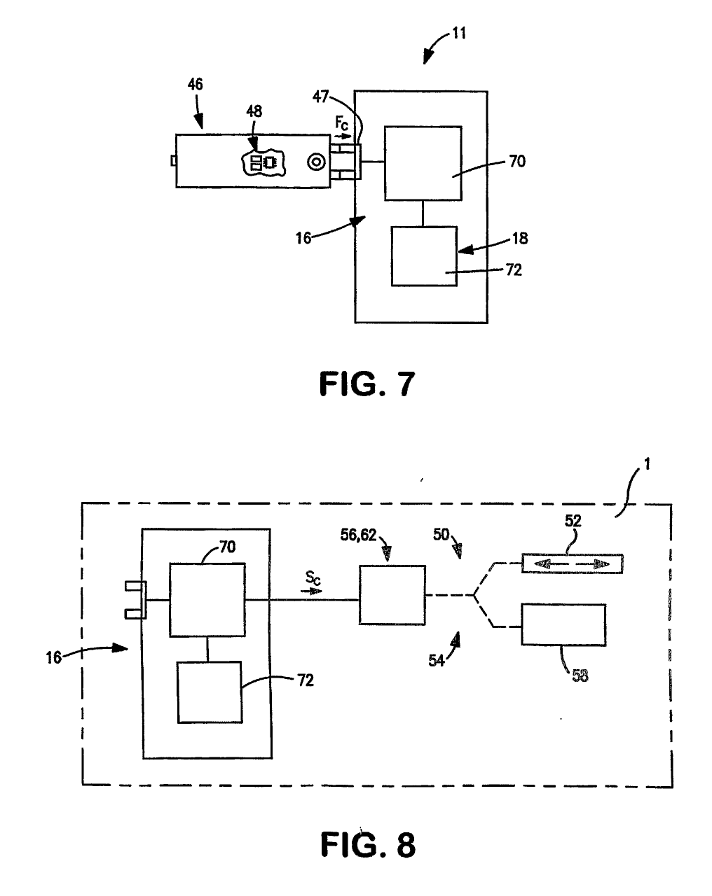

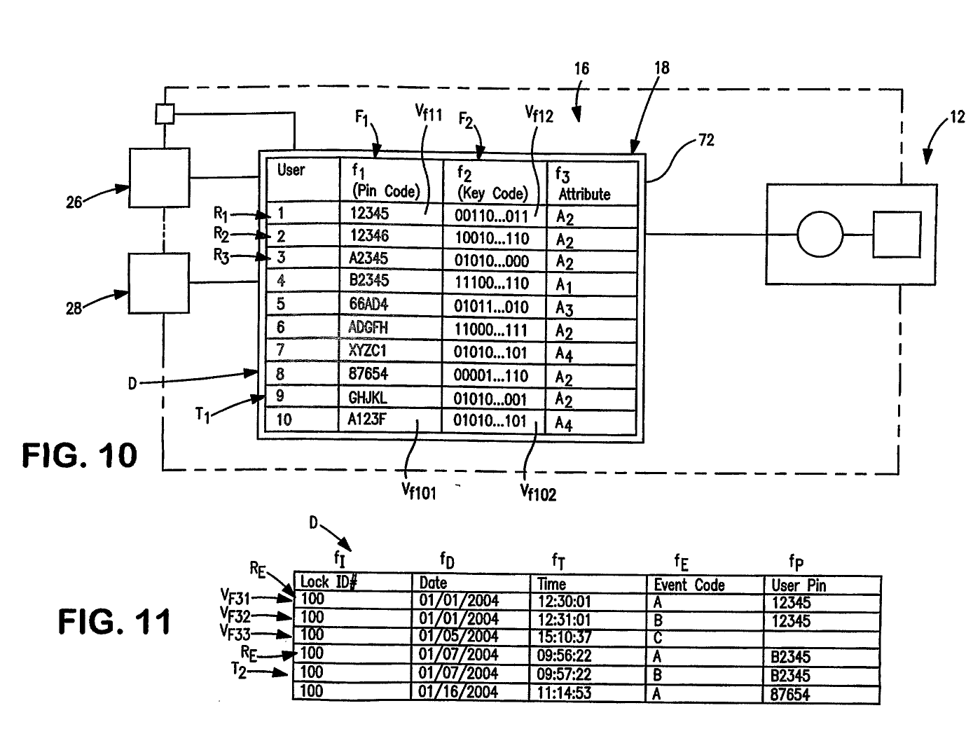

Referring now to the drawings in detail, wherein like numbers are used to indicate like elements throughout, there is shown in FIGS. 1-11 a lock system 10 comprising at least one and preferably a plurality of lock assemblies 11, each lock assembly 11 including a lock 12, at least one input device 14, and a controller 16. Each lock 12 is adjustable between a locked configuration and an unlocked configuration and is associated with a separate door 1 so as to releasably secure the door 1 within a frame 2 when arranged in the locked configuration. Each input device 14 is associated with a separate one of the locks 12 and is configured to generate user input Iₙ, each user input Iₙ, having a value V_{In}, as discussed below. Further, each controller 16 is operatively connected with a separate one of the locks 12 so as to be capable of adjusting the lock 12 between the locked and unlocked configurations, and vice-versa, as described below. Furthermore, the controllers 16 are each coupled with the one or more input devices 14 associated with the particular lock 12, such that the controller 16 receives user input from the particular input device(s) 14. The controllers 16 each have a memory 18 with at least first and second data files F₁, F₂ stored therein, the first file F₁ having at least one and preferably a plurality of stored values V_{F1n}.

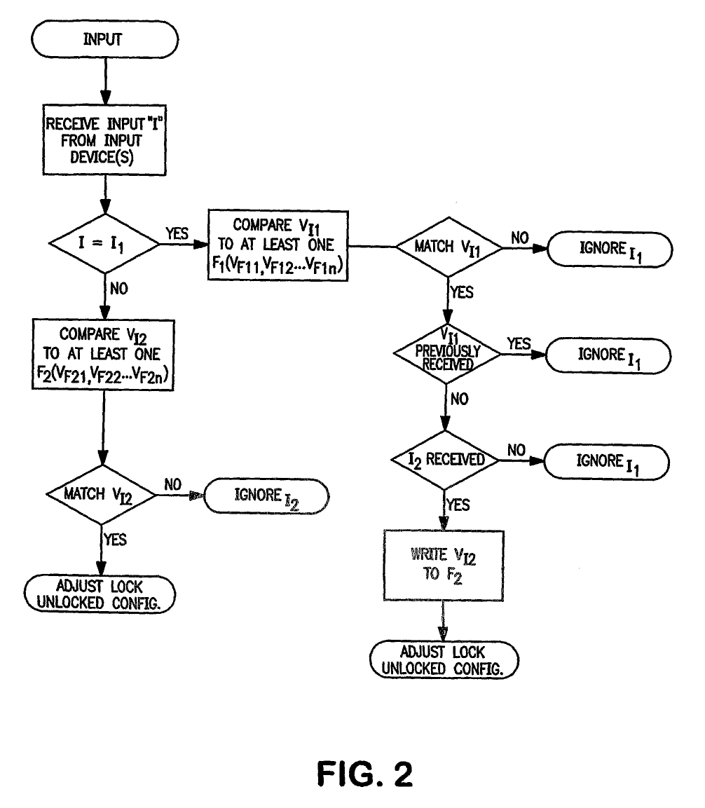

As best indicated in FIG. 2, each controller 16 is configured to receive first and second user inputs I₁, I₂, respectively, from the input device(s) 14. The controller 16 is further configured (i.e., programmed, hard-wired, etc.) to compare the value V_{I1} of the first input I₁ with the one or more values V_{F1n} in the controller first data file F₁ to determine whether or not there is a correspondence or “match” between the particular first input value V_{I1} and at least one of the stored values V_{F1n}. When such a correspondence/match is determined to exist or is “established”, the controller 16 then copies or stores the specific second input value V_{I2} within the second data file F₂ as a value V_{F2n}. As such, the particular second input V_{I2}, which is preferably generated by a value or “key code” C_{Kn} received from a key unit 22 (described below), is thereafter useable to operate (i.e., lock and unlock) the lock 12 associated with that controller 16, as discussed in further detail below. Preferably, the controllers 16 are each constructed or programmed so as “expect” receipt of the first input I₁ prior to receipt of the second input I₂, but may alternatively be configured to receive the first input I₁ subsequent to receipt of, or generally simultaneously with, the receipt of the second input I₂.

Additionally upon the determination of match between the particular first input value V_{I1} and at least one first data file value V_{F1n}, the controller 16 is further configured to adjust the associated lock 12 to the unlocked configuration, thus enabling a user to “open” the associated door 1. Thereafter, the controller 16 adjusts the lock 12 to the unlocked configuration whenever subsequently receiving a second input I₂ with the specific value V_{I2} that has been stored or written into the second data file F₂ (i.e., as stored value V_{F2}). In other words, once the second input value V_{I2} has been stored within the controller memory 18, the associated lock 12 may be operated solely by receipt of that particular second input I₂, for example, from a key unit 22, entered through a keypad 30 (described below), or by any other appropriate means (e.g., retinal scan). Furthermore, each controller 16 is preferably constructed such that the lock 12 is nonadjusted (i.e., the associated door 1 remains locked) whenever the controller 16 subsequently receives a first input I₁ having the particular value V_{I1}. That is, the controller 16 preferably “ignores” each particular first input value V_{I1}, which has been previously received and used to write a second input value V_{I2} into the second data file F₂, whenever that first input value V_{I1} is subsequently entered into the controller 16.

Alternatively, the controller 16 may be configured to adjust the lock 12 to the unlocked configuration only when subsequently receiving both a first input I₁ with the particular value V_{I1} and a second input I₂ with the associated value V_{I2}, i.e., both input values V_{I1} and V_{I2} are required to open the lock 12. As a further alternative, the controller 16 may be set or “programmed” to operate the lock 12 whenever separately receiving either one of the particular first input value V_{I1} or the associated second input value V_{I2}.

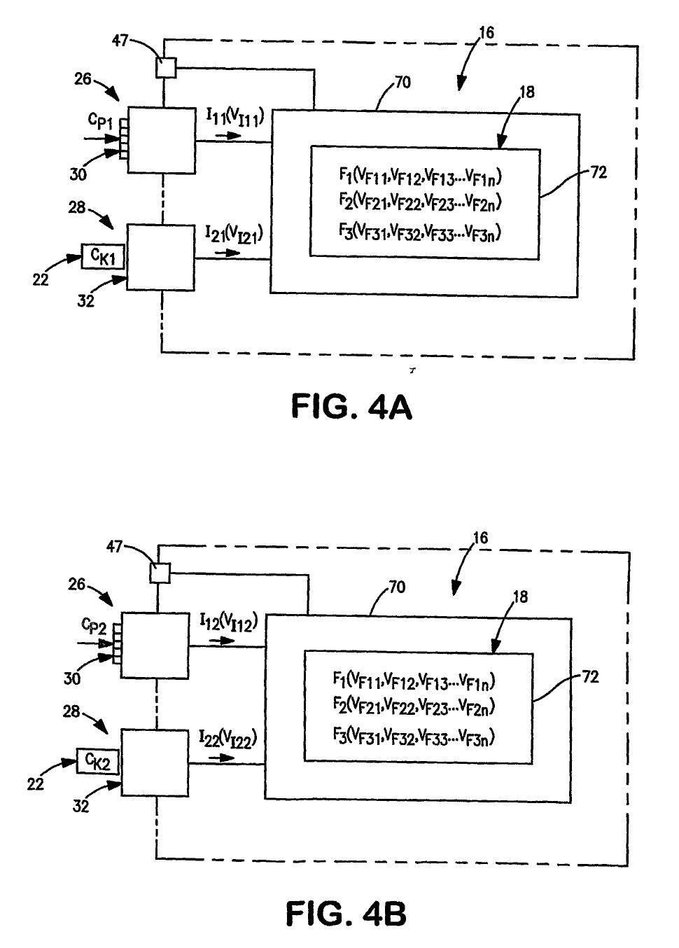

As generally indicated in FIG. 4, each controller 16 is constructed so as to be capable of receiving a plurality of the first inputs I₁₁, I₁₂, etc., and a plurality of the second inputs I₂₁, I₂₂, etc., such that each lock assembly 11 is separately operable by a plurality of different users. The controllers 16 compare each first input value V_{I11}, V_{I12}, etc., with the one or more values V_{F11}, V_{F12}, etc., stored within each controller's first data file F₁. When there is a match between a particular first input value V_{I11}, V_{I12}, etc., and at least one first data file stored value V_{F11}, V_{F12}, etc., each controller 16 copies or stores the associated second input value V_{I21}, V_{I22}, etc., within the controller's second data file F₂ to thereby “enroll” the particular user in the specific lock assembly 11. As such, each controller 16 thereafter adjusts the coupled lock 12 to the unlocked configuration whenever subsequently receiving a second input I₂ having any one of the stored second input values V_{F21}, V_{F22}, etc., as discussed above and in further detail below.

Additionally, the memory 18 of each controller 16 preferably further has a third data file F₃ and each controller 16 is further configured to create and store a value or “event entry” V_{F3} in the third data file F₃ upon the occurrence of certain events associated with a lock 12 or/and door 1. Preferably, such events include at least the following items: 1) adjustment of the lock 12 to the unlocked configuration; 2) adjustment of the lock 12 to the locked configuration; and 3) opening of a door 1 associated with the lock 12 while the lock 12 remains in the locked configuration (i.e., door forced open), and may include any other events associated with the a particular door/lock that are desired to be tracked or monitored. Preferably, each event entry V_{F3} includes 1) a value or code identifying the specific lock 12 or door 1; 2) the date of occurrence of the particular event (e.g., MM(DD/YYYY); 3) the time of event occurrence (e.g., HH:MM:SS); 4) a code representing the particular event; and 5) a value/code representing a particular user (e.g., pin code) when the event involves an authorized use of the lock 12. By generating the event entries V_{F3n}, the controller 16 provides an “audit trail” to the system administrator of the operating history of a particular lock 12 and/or door 1. Thereby, the administrator is able to monitor authorized access to the doors 1 controlled by the lock system 10, is provided with notice of any lock tampering, is able to track specific lock users, etc.

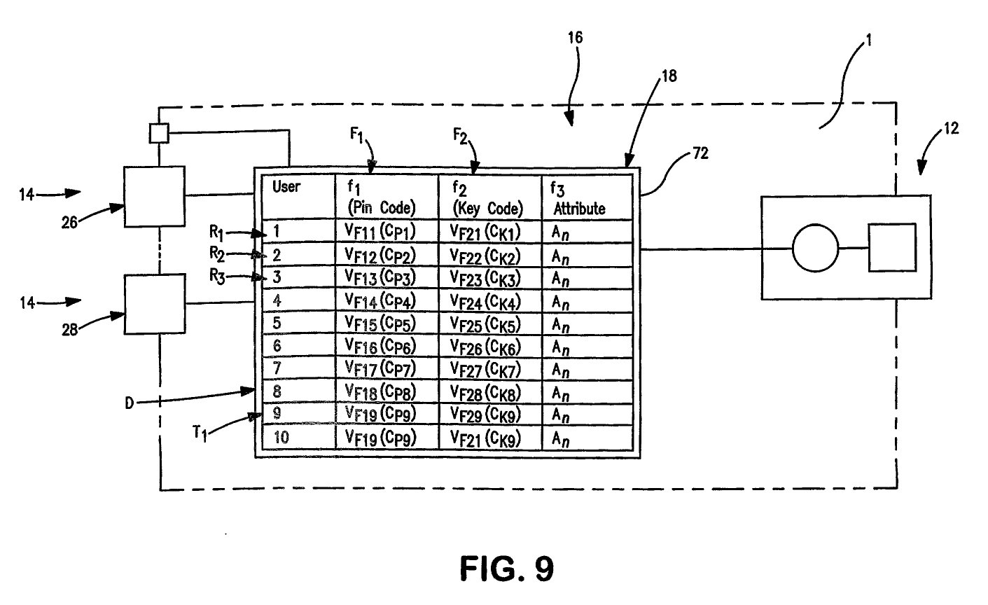

Referring now to FIGS. 9-11, the lock controllers 16 each preferably further include a database D installed within the memory 18 which provides, and also “links”, the first, 5 second, and third data files F₁, F₂, F₃, respectively, and any other desired data files and/or data elements, and described in greater detail below. However, the three preferred data files F₁, F₂, F₃ (and any additional files) may alternatively be configured as separate data files or other data storage units of any appropriate configuration, as generally depicted in FIGS. 2-4.

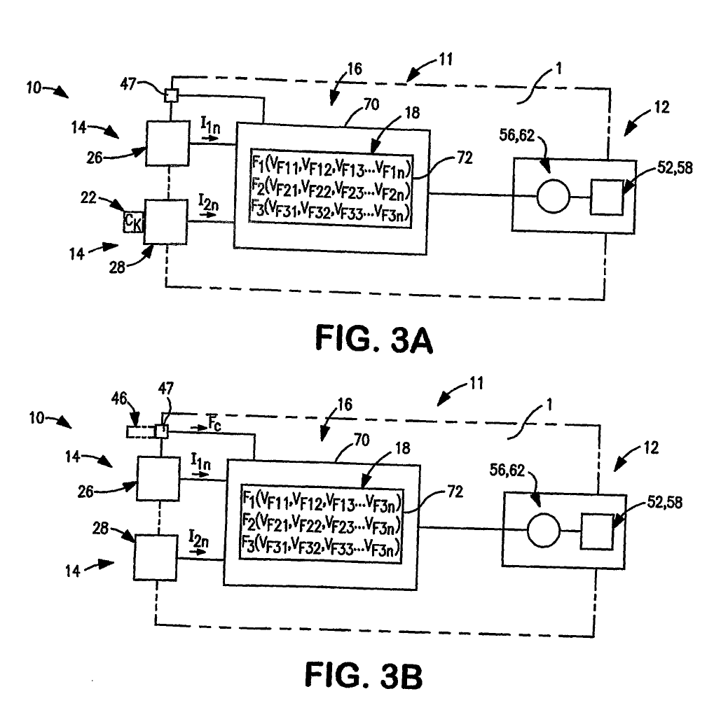

Referring to FIGS. 3-5 and 9-11, each lock assembly 11 preferably includes both a first input device 26 and a second input device 28 each coupled with the associated controller 16 so as transmit input thereto. Specifically, the first input device 26 preferably provides the first user input I₁ to the associated controller 16 and the second input device 28 provides the second user input I₂ to the controller 16. Preferably, each first input device 26 includes a keypad 30 having a plurality of keys 32, each key 32 being actuateable to generate and transmit an electrical signal to the connected controller 16. As such, the first user input I₁ is provided by at least one and preferably a plurality of key-generated electrical signals, the signals corresponding to a “pin code” Cₚₙ assigned to each user and inputted through the keypad 30 thereby. Further, the second input devices 28 each preferably includes an iButton reader 32 configured to receive a key code C_{Kn} from an iButton 34 (as discussed below) and to generate an electrical signal providing the second user input I₂ and to transmit the signal to the controller 16.

Alternatively, either or both of the two preferred input devices 26, 28 may another type of input apparatus, such as for example, a magnetic card reader, a wireless transceiver, a fingerprint scanner, a retinal scanner or other optical scanner, or any other appropriate device configured to receive and/or extract one or more unique “key codes” C_{Kn} from a key device (e.g., a magnetic code from a card stripe, a fingerprint image from a user's finger, etc.) and to generate a corresponding electrical signal providing the user input I₁ or I₂. As a further alternative, each lock assembly 11 may include only a single input device 14 coupled with each controller 16, preferably a keypad 30, and configured to generate both the first and second user inputs I₁, I₂. In such a case, the first and second inputs I₁, I₂ may each include one or more key-generated electrical signals corresponding to a separate one of a pair of pin codes C_{Pn1}, C_{Pn2}, respectively, assigned to each user and entered through the keypad 30, as discussed above.

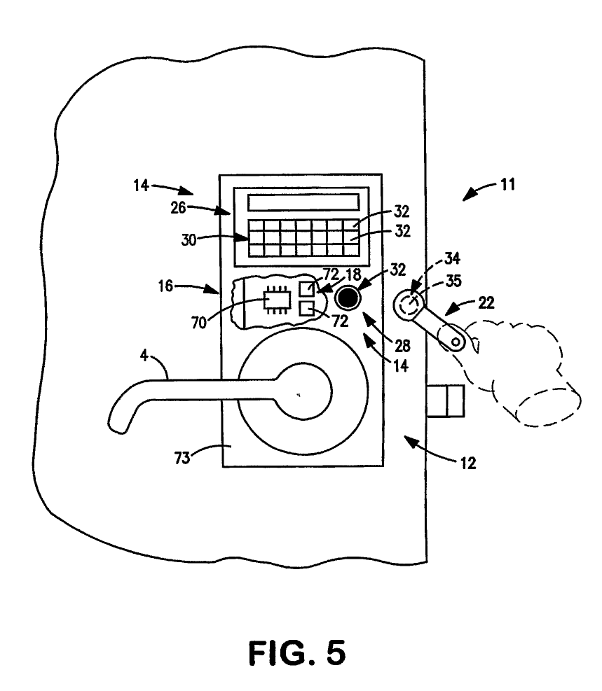

Furthermore, the lock system 10 preferably further comprises at least one and preferably a plurality of the key units 22, at least one key unit 22 being provided or “assigned” to each intended user of at least a portion of the lock system 10, i.e., authorized to access one or more doors 1. Each key unit 22 has stored data corresponding with one second user input I₂, most preferably a key code C_{K}, and is capable of communicating with the input device(s) 14 associated with each controller 16. Preferably, the key unit(s) 22 are each configured to communicate with the second input device 28, most preferably the iButton reader 32, of at least one of the lock assemblies 11. As such, the key units 22 preferably each include an iButton 34 with a memory 35 and is engageable with the iButton reader 32, as best shown in FIG. 5. Most preferably, each key code C_{K} is a sixty-four (64) bit field of data stored within the iButton memory 35, but may have any other appropriate size, format, etc. Alternatively, the key units 22 may include any other appropriate device, such as for example a card with an electromagnetic strip, a mechanical key with an electromagnetic strip(s), etc, or may be provided by a member or physical attribute of the user, such as for example, a fingerprint, a retina, etc. As such, when the second input device 28 is a device such as a fingerprint or retinal scanner, the lock system 10 may be constructed without any separately provided key units 22.

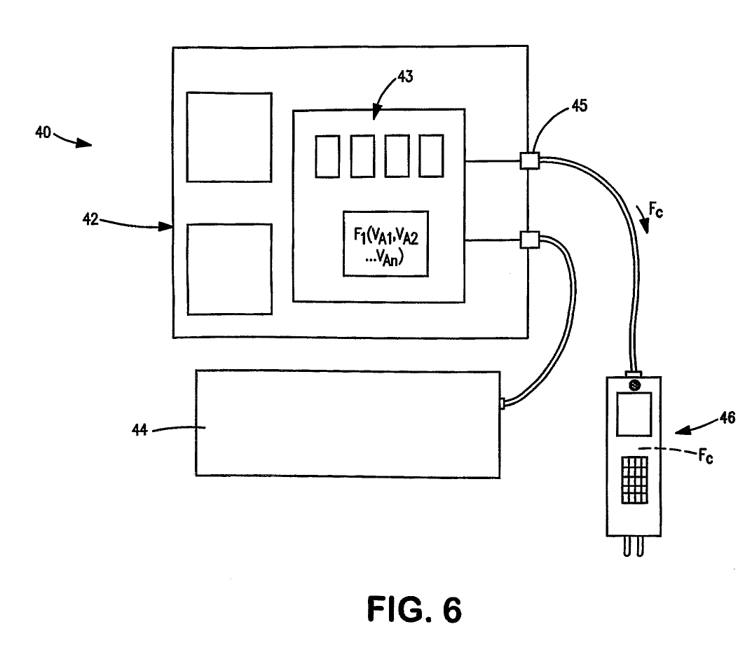

Referring to FIGS. 1 and 6, the lock system 10 also preferably includes a programming device 40 for generating one or more authorization values V_{An}, which are “writable” or “copyable” into the first data file F₁ of at least one controller 16 to provide the first file values V_{F11}, V_{F12}, V_{F13}, etc. Each authorization value V_{An} (and thus each first file value V_{F1n}) preferably corresponds with a pin code C_{P} containing a series of numbers and/or letters, as discussed below, but may have any appropriate form or format. The programming device 40 preferably generates one or more “code” files F_{C} that each contain a plurality of the authorization values V_{An}, and each code file F_{C} is copied into at least one controller 16 to provide the first file values V_{F1n} thereof.

With the preferred pin code format, each authorized user may be assigned a specific pin code C_{P} corresponding to one of the authorization values V_{An}, such that the user may enter the code C_{P} into one or more keypads 30 to thereby “enroll” in the associated controller 16, as discussed above and in further detail below. Preferably, the programming device 40 transfers the code files F_{C}/values V_{An} to the controllers 16 by means of a data transfer device 46 (described below), but may alternatively be directly communicable therewith (e.g., by interconnectable ports, wireless transceivers, etc.).

Still referring to FIGS. 1 and 6, the programming device 40 is preferably a commercially available computer 42 (e.g., personal computer, laptop computer, PDA, etc.), but may alternatively be a specialized electronic device (not shown) manufactured for the sole purpose of programming the controllers 16. The computer 42 is configured to communicate with one or more lock controllers 16, preferably through one or more data transfer devices 46 as described below, so as to transfer the code files F_{C} (or individual values V_{An}) to one or more of the lock controllers 16. The computer 42 includes a software program, such as a text editor or word processor, and an input device 44, such as a keyboard or a mouse, enabling a user to enter commands to the program. The software program is configured to receive user commands and to generate and store a value V_{An} corresponding to each desired pin code C_{Pn}, in whatever appropriate format desired by the user. For example, a user may create three pin codes C_{P1}, C_{P2}, C_{P3}, each having five symbols, such as 12345, ABCDE and 123AB, and stores the corresponding values V_{A1}, V_{A2}, V_{A3}, within a code file F_{C} located in the computer memory 43. Alternatively, the computer 42 may contain a software program configured to automatically generate one or more authorization values V_{An} and/or code files F_{Cn} without the necessity of user input or commands.

Referring to FIGS. 1, 2, 6 and 7, the lock system 10 preferably further comprises at least one data transfer device 46 having a memory 48 with at least one stored data file, preferably the code files F_{C} generated by the computer 42. The code file(s) F_{C} are preferably receivable from the programming device 40 through a serial port 45, or by any other appropriate means (e.g., BUS port, wireless transceiver, etc.). Further, the transfer device 46 is configured to transfer a copy of the code file(s) F_{C} into the first data file F₁ of each controller 16, preferably through a port 47 coupled with the controller 16. As the transfer device 40 may have two or more stored code files F_{C}, the transfer device 46 is configured to selectively transfer at least one of the files F_{C} into each one the lock controllers 16. As such, each controller 16 may be provided with a set of first file values V_{F1n} that is different from the set of values V_{F1n} stored within one or more other controllers 16, thereby enabling user access to be limited to certain doors 1, as discussed in further detail below. Most preferably, the data transfer device 46 is formed or constructed generally in the manner disclosed in co-pending International Patent Application No. PCT/US2005/03776, having an international filing date of 20 Oct. 2005 and entitled “Lock Programming Device”, and claiming priority to U.S. Provisional Patent Application Ser. No. 60/620,622, filed 20 Oct. 2004 of the same title, the entire contents of both noted applications being hereby incorporated by reference herein. However, the data transfer device 46 may be any other appropriate device configured to transfer files to the controller 16, such as for example, a laptop computer, a PDA, etc.

With the above preferred structure, the lock control system 10 of the present invention is intended to basically operate as follows. An administrator of the lock system 10, such as a school staff member, a building security manager, etc., uses the programming device 40 to create at least one set F_{C} of code values V_{An}, then copies at least one set code set F_{C} into the controller 16 of each one of the doors 1 of the system 10 by means of the transfer device 46 (or computer 45). Each user of the system 10, e.g., students, employees, etc., is provided with a separate pin code C_{P} corresponding to one authorization value V_{An} that has been entered into the controllers 16 associated with the specific doors 1 for which the particular user is intended to have access. Each user is also either provided with a key unit 22 having a stored code C_{Kn} providing a specific second input I₂ when engaged with a second input device 28 (e.g., iButton reader 32) or is instructed to use a presently owned or possessed key unit 22 having a unique code that is receivable or extractable by the particular second input device(s) 28 of the lock control system 10. For example, the lock control system 10 may include an input device(s) 28 configured to read or process conventional credit card(s), such that the user merely uses one of their currently possessed credit cards to enroll in the lock system 10, or the inputted device(s) 28 may include one or more scanners configured to “read” at least one user physical feature, such as fingerprints or retinas. In the preferred structure depicted in the drawing figures, the user then “visits” each authorized door 1 and first enters the pin code C_{P} into the preferred keypad 30, then engages the particular key unit 22 (e.g., iButton 34, credit card, etc.) with the second input device 28 (e.g., iButton reader 32, etc.). However, with a lock system 10 having one or more other types of input devices 14 (e.g., a single card reader, a keypad and a fingerprint scanner, etc.), the user enters the first and second inputs I₁, I₂ as appropriate.

With the preferred construction, each controller 16 receives a first input I₁ corresponding to the pin code C_{P} and compares the first input value V_{I1} with the plurality of values V_{I1} in the controller first data file F₁. For each controller 16 associated with an authorized door 1 (i.e., access authorized for that user), the first input I₁ corresponds with one of the values V_{F1n} in the first file F₁, such that the controller 16 then copies the value V_{I2} of the second input I₂ (generated by the key unit code C_{Kn}) into the second data file F₂. Thereby, the specific key unit 22 (and thus the particular user) is “enrolled” into the lock controller 16, such that future access through the associated door 1 is permitted to the user by merely presenting the key unit 22 (i.e., iButton 34), without the necessity of providing the pin code C_{P} (i.e., first input I₁). However, as discussed above, the controller 16 may alternatively be configured to thereafter require both entry of the pin code C_{P} through the keypad 30 and the key code C_{K} through the iButton reader 32. Furthermore, if the user attempts to enter the pin code C_{P} and/or key device code C_{K} into a controller 16 associated with an unauthorized door 1, the controller 16 will compare the pin code first input I₁ with the first data file values V_{F1n} and/or the key code second input I₂ with the second data file values V_{F2n}. When a match or match(es) are not found, the controller 16 will not copy the key code C_{K} into the second data file F₂ and will not adjust the lock 12 to the open configuration.

Having described the basic elements and operation above, these and other aspects of the lock control system 10 of the present invention are described in detail below.

Referring now to FIG. 1, the lock system 10 of the present invention is preferably incorporated into at least one door 1 of at least one building B, and preferably a plurality of doors 1 of a plurality of buildings B₁, B₂, etc. Such building(s) B may be located within an office complex, a college or high school campus, or any other location where multiple users may be provided with access to one or more doors 1 within at least one building B. Further, each door 1 is preferably movably disposed within a frame 2 (e.g., pivotably, slidably, etc.), which may or may not have a strike 3, depending on the particular structure (discussed below) of the associated lock 12. The door 1 is secured to the frame 2 when the associated lock 12 is arranged in the locked configuration, and is displaceable between open and closed positions with respect to the frame 2 when the lock 12 is arranged or disposed in the unlocked configuration.

Referring to FIGS. 1, 3 and 8, each lock 12 is preferably either an electromechanical lock 50 with a moveable member 52 or an electromagnetic lock 54. With the electromechanical lock 50, the moveable member 52 is either a bolt/latch engageable with a strike 3 on a door frame 2, a portion of a clutch device (not shown) engageable with a second member (e.g., spindle) to releasably connect a door handle 4 with a bolt/latch, or a blocking member (not shown) releasably engageable with a handle, spindle, latch, etc., to prevent rotation or displacement thereof. In any of these cases, the electromechanical lock 50 further includes an actuator 56 (e.g., motor, solenoid, etc.) operatively connected with the moveable member 52 to displace the member 52 into and out of engagement with the strike 3, corresponding clutch member or blocked component (e.g., a latch-operating spindle). The actuator 56 is also operably connected with the controller 16 associated with the lock 50. As such, when the controller 16 receives the authorized second input I₂ (e.g., from iButton 34), or combination of authorized first and second inputs I₁, I₂, the controller 16 operates the actuator 56 so as to displace the moveable member 52 to adjust the lock 50 to the “open configuration”, as discussed above.

With the electromagnetic lock 54, the lock 54 includes an electromagnet 58 magnetically engageable with a metallic plate 60 (see FIG. 1) or other metallic member mounted on a door 1 or frame 2 so as to releasably secure the door 1 within the associated frame 2. A relay 62 or similar device is electrically coupled with the electromagnet 58 and with the controller 16 associated with the particular lock 54. With this structure, when the controller 16 receives an authorized second input I₂ (e.g., from iButton 34), or combination of authorized first and second inputs I₁, I₂, the controller 16 operates the relay 62 to cut-off electric power from the electromagnet 58 to release the electromagnetic force from the plate/member 60, thereby adjusting the lock 54 to the open configuration, or otherwise appropriately operating the electromagnetic lock 54.

Although exemplary electromechanical locks 50 and electromagnetic locks 54 are described above, it is within the scope of the present invention to use the lock control system 10 with any other appropriate type of locks 12. For example, the lock control system 10 may be used with an alarm system (not shown) controlling access through one or more doorways each secured by one or more purely mechanical locks (none shown), such that a user is “enrolled” in the alarm system as described herein for authorized access through a door 1 so as to be capable of alternatively disabling or arming the alarm system through an input device(s) 14. The lock system 10 of the present invention is in no manner limited to any particular type of lock or lock application.

Referring to FIGS. 3-5 and 7-10, each controller 16 preferably includes a microprocessor 70 and one or more memory chips 72 coupled with the microprocessor 70 and providing the memory 18. The microprocessors 70 are each electrically connected with the one or more input devices 14 of the particular lock assembly 11, preferably with the first and second input devices 26, 28, thereof, so as to receive the first and second inputs I₁ₙ, I₂ₙ as electrical signals. Further, each microprocessor 70 is electrically connected with either the actuator 56 or relay 62 of the associated lock 12 and is configured to generate and transmit a control signal S_{C} (FIG. 8) to the actuator/relay when the microprocessor 70 determines that the lock 12 should be adjusted or operated, as discussed above. Furthermore, the memory chips 72 are each electrically coupled with the associated microprocessor 70 and have installed therein the data files F₁, F₂, F₃, etc., or the database D providing the files F₁, F₂, F₃, as discussed above and in further detail below. However, one or more (or all) of the controllers 16 may be constructed in any other appropriate manner, such as for example, an analog control device, etc.

Additionally, the microprocessors 70 and memory chips 72 are preferably disposed generally proximal to the lock 12, for example within a housing 73 (FIG. 5) mounted to the door 1 associated with the particular lock 12. However, the controller 16 may alternatively be located remotely from each lock 12 and coupled with the input device(s) 14 and with the lock actuator 56, the relay 62, or other actuator device, by any appropriate communication means, such as a BUS system, a LAN or WAN, an Ethernet, a wireless network, etc. With such a remote arrangement, a single computer or other processing device (none shown) may provide the controller 16 and the memory 18 for a plurality of different lock assemblies 11. Further, a remotely-located controller 16 may connected with the actuator 56, the relay 62, etc., for the one or more lock assemblies 11 either directly (i.e., through the communication means) or through another control component (e.g., a microprocessor, a switch, etc.; none shown) located proximal to the lock 12 and operatively connected with the actuator 56, relay 62, etc.

Referring now to FIGS. 9-11, as discussed above, each one of the controllers 16 preferably includes the database D installed within the controller's memory 18 (e.g., within the chips 72). Each database D includes a first, “user record” table T₁ having a plurality of user records R₁, R₂, R₃, etc., each having at least first and second data fields f₁, f₂, respectively, and preferably at least three data fields f₁, f₂ and f₃, for reasons discussed below. The user records R₁, R₂, R₃, etc., are constructed or arranged so as to link or couple (and also provide) the first and second data files F₁, F₂ of the associated controller 16. Specifically, the first field f₁ of each record Rₙ provides a separate one of the first data file values V₁₁, V₁₂, V₁₃, etc., and the second field f₂ of each record Rₙ provides a second data file value V₂₁, V₂₂, V₂₃, etc., associated with the particular first file value V₁₁, V₁₂, V₁₃, etc., respectively. In other words, each record Rₙ is a linkage of the data file values V₁ₙ and V₂ₙ associated with each user of the lock system 10, such that each first field fin provides the value corresponding with the user's pin code Cₚₙ (first file value V₁ₙ) and each second field f₂ₙ provides the value corresponding with the user's key code C_{Kn} (second file value V₂ₙ).

Furthermore, each record Rₙ of the controller database D also preferably includes a third field f₃ having either a first, second, third or fourth attribute value A₁, A₂, A₃, A₄, respectively. The controller 16 is configured to separately adjust the third field f₃ of each record Rₙ to any one of the four attribute values A₁, A₂, A₃, A₄, and preferably to enable an administrator to select and adjust the specific attribute Aₙ for each user record Rₙ to control the user's manner of access, as follows. The controller 16 preferably operates the lock 12 such that the lock 12 is adjusted to the open configuration under one of the following circumstances:
1) when the controller 16 receives a first input value V₁ₙ corresponding with one record first field value f_{1V} and the associated third field f₃ has the first attribute value A₁;
2) when the controller 16 receives a second input value V₂ₙ corresponding with one record second field value f_{2V} and the associated third field f₃ has the second attribute value A₂; or
3) when the controller 16 receives both a first input value V₁ₙ corresponding with one record first field value f_{1V} and a second input value V₂ₙ corresponding with the second field value f_{2V} of the particular record Rₙ and the associated third field f₃ has the third attribute value A₃.

However, the controller 16 is also configured such that the lock 12 is nonadjusted (i.e., remains locked) when the third field f₃ of a particular record Rₙ is set to the fourth attribute value A₄, even upon receipt of any of the following: a first input value V_{I1} corresponding with the record first field value V_{f1n}, a second input value V_{I2} corresponding with the record second field value V_{f2n}, or both first and second input values V_{I1}, V_{I2} corresponding with the record first and second field values V_{f1n}, V_{f2n}, respectively. As such, when the third field f₃ of any record Rₙ is set to the fourth attribute value A₄, the controller 16 denies or prevents access to the user associated with the particular record Rₙ, even when the user presents an authorized pin code C_{P} or/and an authorized key unit 22. By providing the records Rₙ with the third field f₃, each controller 16 has the flexibility to require different access conditions for different users, to change the access conditions for a particular user, and to deny access to a previously authorized user.

Referring particularly to FIG. 1, each database D preferably further includes a second, “Lock History” table T₂ having a plurality of stored event entries V_{F3n} or event records R_{E}, which thus provides the controller third data file F₃ as described above. With this database structure, the controllers 16 of the lock system 10 are each configured to write an event record R_{E} upon the occurrence of certain predetermined events, for example, the authorized unlocking or locking, or forced entry, of a door 1. Preferably, each event record R_{E} includes a lock identifier field f_{I}, a date field f_{D}, a time field f_{T}, an event code field f_{E}, and a user pin field f_{P}, the field values being written into a single event record V_{F3n} upon the occurrence of one of the predetermined events. For example, an authorized unlocking event may be indicated by an “A”, an authorized locking event by a “B”, and a forced entry event by a “C”, the forced entry thus not being associated with any user pin, as shown in FIG. 11. Further, by writing an identifier code (e.g., 100) for the specific lock 12, the particular data entries of the lock history table T₂ may be later associated with that lock 12 when the table T₂ has be copied (e.g., by a data transfer device 46, etc.) during an audit process.

Alternatively, the database first table T₁ may further include a fourth field (not shown) for each user record, the fourth field containing one or more event entries V_{F3n}. With this data structure, one event record value V_{F3n} is written into the fourth field of a particular user's record Rₙ whenever that user performs an authorized activity (e.g., unlocks or locks a door). However, such a data structure would require other means to record the occurrence of unauthorized activity (e.g., forced entry of door 1), as such actions would not likely be readily identified with a specific user.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined in the appended claims.

We claim:

1. A lock system comprising:
a lock adjustable between a locked configuration and an unlocked configuration;
at least one input device configured to at least one of generate user input and receive user input, each user input having a value; and
a controller operatively connected with the lock, coupled with the input device so as to receive user input, having a memory with at least first and second data files, the first file having at least one stored value, the controller being configured to receive first and second user inputs and to compare the first input value with the at least one first file value and to store a particular second input value within the second data file when a particular value of the first input corresponds with at least one value in the first file.

2. The lock system as recited in claim 1 wherein the controller is further configured to adjust the lock to the unlocked configuration when the particular first input value corresponds with at least one first file value.

3. The lock system as recited in claim 2 wherein the controller is configured such that the lock is nonadjusted whenever the controller subsequently receives a first input having the particular value.

4. The lock system as recited in claim 2 wherein the controller is configured to adjust the lock to the unlocked configuration whenever the controller subsequently receives a second input having a value corresponding with the particular second input value stored within the second data file.

5. The lock system as recited in claim 2 wherein the controller is configured to adjust the lock to the unlocked configuration whenever the controller subsequently receives both a first input having a value corresponding with the particular first file value and a second input having a value corresponding to the particular second file value.

6. The lock system as recited in claim 1 wherein the controller memory further has a third data file, the controller being configured to create and store a value in the third data file at least one of when the lock is adjusted to the unlocked configuration, when the lock is adjusted to the locked configuration, and when a door associated with the lock is opened with the lock in the locked configuration.

7. The lock system as recited in claim 1 wherein the controller is further configured to receive at least one other first input and at least one other second input, to compare the value of the other first input with the at least one value stored within the first data file, and to store a particular other second input value in the second data file when a particular other first input value corresponds with at least one value within the first data file.

8. The lock system as recited in claim 7 wherein the controller is configured to adjust the lock to the unlocked configuration whenever the controller subsequently receives a second input having the particular second input value and alternatively whenever the controller subsequently receives a second input having the particular other second input value.

9. The lock system as recited in claim 1 wherein the controller includes a database installed within the memory and including a plurality of user records each having at least first and second fields, the user records being configured to couple the first and second data storage units such that the first field of each record provides a separate one of the first storage unit values and the second field of each record provides a second storage unit value associated with the particular first unit value.

10. The lock system as recited in claim 9 wherein each record further includes a third field and the controller is configured to store a value corresponding to at least one of a time, a date, and an event code within the third field whenever the controller receives at least one of a first user input having a value corresponding the first field value of the record and a second user input having a value corresponding the second field value of the record.

11. The lock system as recited in claim 9 wherein the event code indicates at least one of when the lock is adjusted to the unlocked configuration, when the lock is adjusted to the locked configuration, and when a door associated with the lock is opened with the lock in the locked configuration.

12. The lock system as recited in claim 9 wherein:
each record further includes a third field having one of a first, second and third attribute values; and
the controller is configured to operate the lock such that the controller adjusts the lock to the open configuration when one of:
the controller receives a first input value corresponding with one record first field value and the associated third field has the first attribute value;
the controller receives a second input value corresponding with one record second field value and the associated third field has the second attribute value; and
the controller receives both a first input value corresponding with one record first field value and a second input value corresponding with the one record second field value and the associated third field has the third attribute value.

13. The lock system as recited in claim 12 wherein:
each record third field has one of the first attribute value, the second attribute value, the third attribute value and a fourth attribute value; and
the controller is configured such that the lock is nonadjusted when one of:
the controller receives a first input value corresponding with one record first field value and the third field of the particular record has the fourth attribute value;
the controller receives a second input value corresponding with one record second field value and the third field of the particular record has the fourth attribute value; and
the controller receives both a first input value corresponding with one record first field value and a second input value corresponding with the one record second field value and the associated third field has the fourth attribute value.

14. The lock system as recited in claim 13 wherein the controller is configured to separately adjust each record third field to any one of the first, second, third and fourth attribute values.

15. The lock system as recited in claim 1 wherein:
the input device is a first input device, the first input device being configured to provide the first user input to the controller; and
the lock system further comprises a second input device configured to provide the second user input to the controller.

16. The lock system as recited in claim 15 wherein:
the first input device is one of a keypad having a plurality of keys, each key being actuateable to generate an electrical signal, a card reader the first user input being provided by at least one key electrical signal; and
the second input device includes one of a card reader, an iButton reader, a wireless transceiver, a fingerprint scanner and a retinal scanner, the second input device being configured to generate an electrical signal providing the second user input.

17. The lock system as recited in claim 1 wherein the input device is configured to generate both the first and second user inputs.

18. The lock system as recited in claim 17 wherein the input device includes one of a keypad, a card reader, an iButton reader and a wireless transceiver.

19. The lock system as recited in claim 1 wherein the first input is received by the controller one of prior to receipt of the second input by the controller, subsequent to receipt of the second input by the controller, and generally simultaneously with receipt of the second input by the controller.

20. The lock system as recited in claim 1 further comprising at least one key unit having data corresponding with a second user input and being configured to communicate with the at least one input device.

21. The lock system as recited in claim 20 wherein the key unit includes one of a card with electromagnetic storage and an iButton with a memory.

22. The lock system as recited in claim 1 wherein the lock system further comprises:
a plurality of the locks, each lock being coupled with a separate one of a plurality of doors and adjustable between the locked and unlocked configurations;
a plurality of the input devices each configured to receive user input, each input having a value, at least one input device being associated with each one of the plurality of locks; and
a plurality of the controllers, each controller being operatively connected with a separate one the locks, coupled with the at least one input device associated with the connected lock so as to receive user input, having a memory with at least first and second data files, the first file having at least one value, each controller being configured to receive first and second user inputs and to compare the first input value with the at least one first file value and to store a particular second input value within the second file when a particular first input value corresponds with one first file value.

23. The lock system as recited in claim 22 wherein the first file of each controller has a set of a plurality of values, each controller first file having the same value set as each one of the other controller first files.

24. The lock system as recited in claim 23 further comprising a data transfer device having a memory with a stored data file, the data file including a plurality of values, the data transfer device being configured to transfer a copy of the plurality of values into the first data file of each one of the controllers.

25. A method of managing a plurality of lock assemblies, the method comprising the steps of:
providing a plurality of the lock assemblies, each lock assembly being disposed on a separate door and including a lock adjustable between a locked configuration and an unlocked configuration, and an input device configured to generate user input, and a controller operatively connected with the lock, coupled with the input device so as to receive user input, having a memory with at least first and second data files;
storing at least one first value into each lock first data file;
inputting first and second user values into at least one of the plurality of lock controllers; and
storing the second user value in the controller second data unit when the at least one controller determines that the first user value corresponds with at least one value stored in the controller first data file such that the at least one controller is configured to adjust the lock to the unlocked configuration whenever the second user value is subsequently inputted to the at least one controller.

26. The method as recited in claim 25 wherein the step of storing at least one first data file value includes:
providing a programming device having a memory with a set of values; and
copying the set of values from the programming device memory into the lock controller first storage unit of each one of the locks.

27. The method as recited in claim 26 further comprising the steps of:
adjusting the lock to the unlocked configuration upon an initial receipt by the at least one controller of a particular first user value corresponding with at least one value stored in the controller first data file; and
nonadjusting the lock to the unlocked configuration whenever the controller subsequently receives a first input having the particular first user value.

28. The method as recited in claim 25 wherein the memory of the at least one controller further has a third data file and the method further comprises the step of creating and storing a value in the third data file when at least one of the lock connected with the at least one controller is adjusted to the unlocked configuration, the lock connected with the at least one controller is adjusted to the locked configuration, and the door associated with the at least one controller is opened with the lock connected with the at least one controller being in the locked configuration.

29. A lock system comprising:
a lock adjustable between a locked configuration and an unlocked configuration;
at least one input device configured to generate user input, each user input having a value; and
a controller operatively connected with the lock, coupled with the input device so as to receive user input, and including a database having at least one record with first and second fields, the first field having a value, the controller being configured to receive first and second user inputs and to compare the first input value with the first field value and to store the second input value within the second field when the particular first input value corresponds with the first field value.

30. A lock system for a door disposed within a frame, the lock system comprising:
a lock adjustable between a locked configuration and an unlocked configuration;
at least one input device configured to receive user input, each user input having a value; and
a controller operatively connected with the lock, coupled with the input device so as to receive user input, having a memory with at least first and second data files, the first file having at least one value, the controller being configured to receive two user inputs and to compare the value of a predetermined one of the two inputs with the at least one first file value and to store the value of the other one of the two inputs within the second file when the particular value of the one input corresponds with one first file value.

31. A lock system comprising:
a lock adjustable between a locked configuration and an unlocked configuration;
a first and second input devices each configured to generate user input, each input having a value; and
a controller operatively connected with the lock, coupled with the first and second input devices so as to receive user input, having a memory with at least first and second data files, the first file having at least one stored value, the controller being configured to receive first user input from the first input device and second user input from the second input device, to compare the first input value with the at least one first file value, and to store the second input value within the second file when the particular value of the first input corresponds with at least one value in the first file.

32. A method of managing a plurality of lock assemblies, the method comprising the steps of:
providing a plurality of the lock assemblies, each lock assembly including a lock adjustable between a locked configuration and an unlocked configuration, and an input device configured to generate user input, and a controller operatively connected with the lock, coupled with the input device so as to receive user input, and having a memory with at least first and second data files;
providing a programming device having a memory with a set of values;
copying the set of values from the programming device memory into the lock controller first data file of each one of the locks;
inputting first and second user values into at least one the lock controllers; and
storing the second user value in the controller second data unit when the at least one controller determines that the first user value corresponds with at least one of the set of values stored in the controller first data file such that the at least one controller is configured to adjust the lock to the unlocked configuration whenever the second user value is subsequently inputted to the at least one controller.
